(19) United States
(12) Patent Application Publication
(10) Pub. No.: US 2026/0079090 A1
(43) Pub. Date: Mar. 19, 2026

(54) An Electrically Assisted Tension-Compression Cyclic Loading Device and Testing Method for Ultra-Thin Titanium Plates

(71) Applicant: Northwestern Polytechnical University, Xi'an (CN)

(72) Inventors: Yanfeng YANG, Xi'an (CN); Wentao CAI, Xi'an (CN); Heng LI, Xi'an (CN); Zhenguan CHU, Xi'an (CN); Zhen FANG, Xi'an (CN)

(73) Assignee: Northwestern Polytechnical University, Xi'an (CN)

(21) Appl. No.: 19/399,579

(22) Filed: Nov. 24, 2025

(30) Foreign Application Priority Data
May 22, 2025 (CN) 202510661116.8

(51) Int. Cl. G01N 3/32; G01N 3/04

(52) U.S. Cl. CPC G01N 3/32; G01N 3/04; G01N 2203/0218

(57) ABSTRACT

The present invention discloses an electro-assisted tension-compression cyclic loading device and testing method for ultra-thin titanium plates. The device comprises a composite tension-compression specimen, wherein a lateral force is applied to both sides of the composite tension-compression specimen; two pairs of electro-assisted fixtures, respectively clamping both ends of the composite tension-compression specimen, include two oppositely arranged clamping heads. The clamping surface of the clamping heads have a conductive structure, and the conductive structure is connected to an external power source, so that when the composite tension-compression specimen is clamped on the clamping head, the conductive structure contacts the composite tension-compression specimen to transfer current to the composite tension-compression specimen through the conductive structure to heat it. The clamping head is further connected to the loading end of a universal testing machine. The present invention can avoid torsional deformation of the ultra-thin titanium plate specimen during the test.

### TECHNICAL FIELD

The present invention relates to the technical field of electro-assisted tension-compression testing, and more particularly to an electro-assisted tension-compression cyclic loading device and testing method for ultra-thin titanium plates.

### BACKGROUND

With the increasing demand for lightweight and high-performance materials in industries such as aerospace, transportation, and automobile manufacturing, titanium and titanium alloys, which possess high specific strength, are being widely used. However, titanium exhibits poor plasticity at room temperature and has a high deformation resistance and yield ratio, which severely limits the application of ultra-thin titanium sheets.

In response to the poor formability of titanium at room temperature, the electro-assisted forming process has emerged. However, the deformation behavior of ultra-thin titanium sheets during electro-assisted forming is complex. The rounded corners during the stamping process undergo complex deformation loading paths such as loading-unloading, reverse loading, and cyclic loading. The electro-assisted uniaxial tensile test is difficult to characterize. The electro-assisted tension-compression cyclic loading test device is usually used to test the ultra-thin titanium sheet to characterize the mechanical behavior of the ultra-thin titanium sheet under the complex loading path of the current. At present, the thin plate tension-compression test device mainly applies lateral force to the left and right clamping plates to prevent the ultra-thin titanium sheet sample located in the middle of the two clamping plates from instability and buckling during the compression process, and applies the tension-compression load to the upper and lower ends of the ultra-thin titanium sheet through the fixture of the universal testing machine to realize the tension-compression process of the sample. However, the test process is often affected by the wrinkling deformation of the sample. If the ultra-thin titanium sheet is too thin, it is difficult to ensure that the ultra-thin titanium sheet does not undergo torsional deformation only through the clamping plate and the sample fixture. Existing electro-assisted tension-compression tests mainly apply an electric field by designing a special sample with a wire interface, and the connection between the wire and the ultra-thin sample is prone to kinking.

### SUMMARY

In order to solve the above technical problems, the present invention provides an electric-assisted tension-compression cyclic loading device and testing method for ultra-thin titanium plates, which can avoid twisting deformation of the ultra-thin titanium plate specimen during the test.

In a first aspect, the present invention provides an electric-assisted tension-compression cyclic loading device for ultra-thin titanium plates, including: two outer specimens used in conjunction with the ultra-thin titanium plate specimen, the two outer specimens being fixed on both sides of the ultra-thin titanium plate specimen, and the three forming a composite tension-compression specimen, the ends of the ultra-thin titanium plate specimen extending beyond the ends of the outer specimens, lateral force is applied to both sides of the composite tension-compression specimen after being fixed by a clamping assembly, two pairs of electric-assisted clamps are respectively clamped at both ends of the composite tension-compression specimen, each pair of electric-assisted clamps includes two oppositely arranged clamping heads, the clamping surface of the clamping head has a conductive structure, the conductive structure is connected to an external power source, when the composite tension-compression specimen is clamped on the clamping head, the conductive structure contacts the composite tension-compression specimen to transfer current to the composite tension-compression specimen through the conductive structure to heat it, the clamping head is connected to the loading end of the universal testing machine, the composite tension-compression specimen should ensure a moderate thickness, if it is too thin, it is still prone to twisting during the compression process, if it is too thick, the specimen is not easy to be clamped, at the same time, the two outer specimens are fixed on both sides of the ultra-thin titanium plate specimen to form a composite tension-compression specimen structure, which can also ensure uniform force transmission.

Optionally, the resistivity of the outer specimen is 1012 Ω·m-1017 Ω·m, and it can be considered that it is insulated when the resistivity is in the range of 1012 Ω·m-1017 Ω·m, and the current has basically no effect on the outer specimen.

Optionally, the conductive structure includes an integrated conductive sheet and a connecting sheet, both the conductive sheet and the connecting sheet are made of conductive materials, the conductive sheet is located on the clamping surface of the clamping head, and the side in contact with the composite tension-compression specimen has serrations, the conductive sheet is also provided with a through slot, the end of the outer specimen is placed in the through slot, the ultra-thin titanium plate specimen contacts the conductive sheet, the connecting sheet is connected to an external power source, the conductive sheet is responsible for transmitting current and heating the ultra-thin titanium plate specimen, and the connecting sheet is connected to an external power source, responsible for transmitting the current from the external power source to the conductive sheet.

Optionally, the upper and lower clamps of the universal testing machine correspondingly clamp two pairs of electric-assisted clamps, the clamping head also has a positioning post and a fixing groove, the positioning post cooperates with the positioning groove of the universal testing machine, and the loading head of the universal testing machine is snap-fitted into the fixing groove, so as to achieve the purpose of quickly completing the connection and alignment with the universal testing machine, accurately positioning the relative position of the electric-assisted clamp and the universal testing machine clamp, and ensuring the centering and stability during the loading process.

Optionally, the thickness of the outer specimen is 0.5 mm-0.7 mm, and the material is one of glass fiber composite material or polyetheretherketone or carbon fiber-glass fiber composite material, or other composite materials with good insulation and high temperature resistance and elongation.

Optionally, the outer specimen and the ultra-thin titanium plate specimen are bonded and fixed with epoxy resin, and the layer thickness of the epoxy resin is 0.02 mm-0.05 mm, selecting a layer thickness in the range of 0.02 mm-0.05 mm can ignore the tensile and compressive force on the resin layer, which is convenient for subsequent calculation.

Optionally, the clamping assembly includes: two insulating shims arranged symmetrically on both sides of the composite tension-compression specimen, each insulating shim includes a first insulating sheet and a second insulating sheet stacked along the extending direction of the ultra-thin titanium plate specimen, and two clamping plates arranged symmetrically on the outside of the two insulating shims, the outside of the clamping plate is connected with a lateral force adjusting assembly, each clamping plate includes a first clamping plate and a second clamping plate stacked, the first clamping plate is fixedly connected with the corresponding first insulating sheet, the second clamping plate is fixedly connected with the corresponding second insulating sheet, the first insulating sheet and the second insulating sheet, and the first clamping plate and the second clamping plate are slidably connected through a plurality of straight rods, so that the first insulating sheet and the second insulating sheet, and the first clamping plate and the second clamping plate move synchronously along the extending direction of the ultra-thin titanium plate specimen, the insulating shim is used to isolate current, and the clamping plate is used to transmit lateral force.

Optionally, the first insulating sheet and the second insulating sheet, and the first clamping plate and the second clamping plate are also connected through a comb-shaped structure, the comb-shaped structure ensures that all sections can be constrained by lateral force when the composite tension-compression specimen is compressed after being stretched.

Optionally, the lateral force adjusting assembly includes: two inner plates, two outer plates and a spring, the two inner plates are respectively placed on the outside of the corresponding clamping plates, the two outer plates are respectively placed on the outside of the corresponding inner plates, the inner plate and the outer plate are both provided with sliding holes along the extending direction of the ultra-thin titanium plate specimen, the screw passes through the sliding holes in sequence and is fixed with the clamping plate and the insulating shim, one of the outer plates is rotatably connected with a spring adjusting block, one end of the spring is fixedly connected with the spring adjusting block, and the other end is fixedly connected with the corresponding inner plate, the compression force of the spring is adjusted by rotating the spring adjusting block, so as to adjust the lateral force applied to one side of the inner plate, in this way, it is convenient to adjust by only setting the spring adjusting block and the spring on one side, and the lateral force can be collected by the force sensor on the other side.

In a second aspect, the present invention provides a testing method based on the above-mentioned electric-assisted tension-compression cyclic loading device for ultra-thin titanium plates, including the following steps:
Step 1: Prepare a composite tension-compression specimen, and fix outer specimens on both sides of the ultra-thin titanium plate specimen to form a composite tension-compression specimen;
Step 2: Clamp the prepared composite tension-compression specimen to the universal testing machine through electric-assisted clamps, and apply lateral force to the composite tension-compression specimen through the clamping assembly on both sides for fixing;
Step 3: Set the parameters required for the tension-compression test and perform the tension-compression test;
Step 4: Observe whether the ultra-thin titanium plate specimen buckles, if buckling occurs, adjust the lateral force, and then repeat steps 1-4 until the ultra-thin titanium plate specimen does not buckle, and obtain the corresponding lateral force when no buckling occurs;
Step 5: Use the corresponding lateral force when no buckling occurs to fix the remaining composite tension-compression specimens, and perform a tension-compression test to obtain experimental data, and use the experimental data to obtain a stress-strain curve.

The technical solution provided by the embodiments of the present invention has the following advantages compared with the prior art:

The electric-assisted tension-compression cyclic loading device and testing method for ultra-thin titanium plates provided by the embodiments of the present invention are used for compression tests of thin plates with a thickness of less than 1 mm. By fixing two outer specimens on both sides of the original ultra-thin titanium plate specimen to form a composite tension-compression specimen as a whole, the thickness of the specimen is increased, which can avoid instability and buckling during the compression process. At the same time, two pairs of electric-assisted clamps clamp the composite tension-compression specimen, the conductive structure on each clamping head of the electric-assisted clamp is directly connected to the composite tension-compression specimen to heat it, by connecting the composite tension-compression specimen with the electric-assisted clamp to form a whole to replace the original ultra-thin titanium plate specimen, it avoids setting wire interfaces on the specimen, and further avoids the twisting deformation of the specimen, solves the problem of wrinkling of the ultra-thin plate under compression load, ensures the smooth progress of the test, and then connects the clamping head and the loading end of the universal testing machine, which can be used to characterize the mechanical behavior of the ultra-thin titanium plate under complex loading paths under current conditions, and provide theoretical support for the electric-assisted forming process.

### BRIEF DESCRIPTION OF THE DRAWINGS

FIG. 1 is a schematic structural diagram of an electro-assisted tension-compression cyclic loading device for ultra-thin titanium plates provided by an embodiment of the present invention;

FIG. 2 is an exploded schematic structural diagram of an electro-assisted tension-compression cyclic loading device for ultra-thin titanium plates provided by an embodiment of the present invention;

FIG. 3 is a schematic structural diagram of a composite tension-compression specimen in a first orientation provided by an embodiment of the present invention;

FIG. 4 is a schematic structural diagram of a chuck provided by an embodiment of the present invention;

FIG. 5 is a schematic structural diagram of a first insulating sheet and a second insulating sheet provided by an embodiment of the present invention;

FIG. 6 is a schematic structural diagram of a first clamping plate and a second clamping plate provided by an embodiment of the present invention;

FIG. 7 is a schematic structural diagram of a composite tension-compression specimen in a second orientation provided by an embodiment of the present invention;

FIG. 8 is an enlarged schematic diagram of the local structure at G in FIG. 7.

### DESCRIPTION OF REFERENCE NUMERALS

1. Outer specimen; 2. Ultra-thin titanium plate specimen; 3. First insulating sheet; 4. Second insulating sheet; 5. Spring; 6. Spring adjusting block; 7. Force sensor; 8. Outer plate; 9. Inner plate; 10. Straight rod; 11. Chuck; 12. First clamping plate; 13. Second clamping plate; 14. Thermocouple; 15. Conductive structure; 150. Conductive sheet; 151. Connecting piece; 152. Through slot; 16. Positioning post; 17. Fixing groove; 18. Insulating layer.

### DETAILED DESCRIPTION OF EMBODIMENTS

Hereinafter, a specific embodiment of the present invention will be described in detail with reference to the accompanying drawings. However, it should be understood that the scope of protection of the present invention is not limited by the specific embodiment.

In the description of the present invention, it should be understood that the orientations or positional relationships indicated by the terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “axial”, “radial”, “circumferential”, etc., are based on the orientations or positional relationships shown in the drawings, and are only for the purpose of facilitating the description of the technical solutions of the present invention and simplifying the description, but not for indicating or implying that the device or element referred to must have a specific orientation, and be constructed and operated in a specific orientation. Therefore, it cannot be understood as a limitation to the present invention.

When the existing electro-assisted tension-compression cyclic loading testing device tests ultra-thin titanium plates, buckling deformation occurs in the ultra-thin titanium plates. For example, because the thickness of the ultra-thin titanium plate is too thin, the pressure is difficult to be transmitted from both ends of the specimen to the gauge section during the compression process, and the transition area between the clamping section and the gauge section is prone to torsion. It is difficult to ensure that the ultra-thin titanium plate does not undergo torsional deformation only through the clamping plate and the specimen fixture. Also, the existing electro-assisted tension-compression test mainly applies an electric field by designing a special specimen with a wire interface. The connection between the wire and the ultra-thin specimen is prone to twisting, which affects the test.

Therefore, the embodiments of the present invention provide an electro-assisted tension-compression cyclic loading device and testing method for ultra-thin titanium plates, which can avoid torsional deformation of the ultra-thin titanium plate specimen during the test.

The present invention will be described below through several specific embodiments. In order to keep the following description of the embodiments of the present invention clear and concise, detailed descriptions of known functions and known components may be omitted. When any component of the embodiments of the present invention appears in more than one drawing, the component may be represented by the same reference numeral in each drawing.

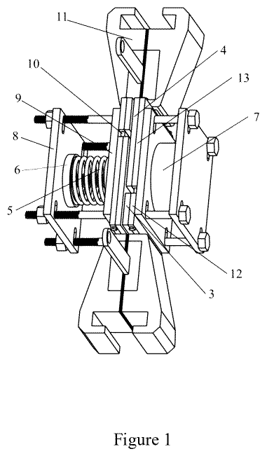

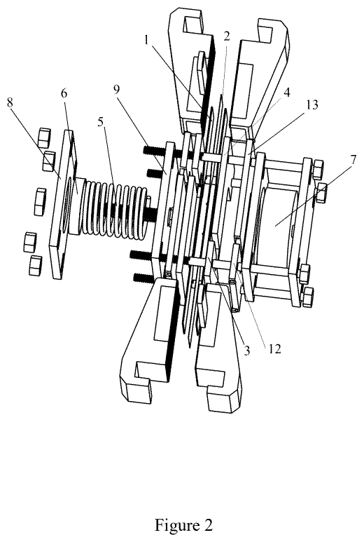

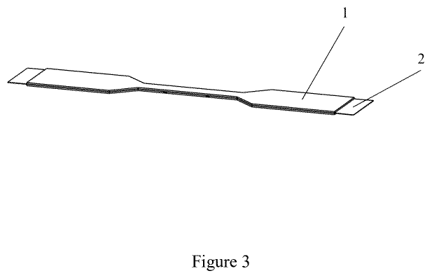

Referring to FIG. 1, FIG. 2 and FIG. 3, FIG. 1 is a schematic structural diagram of an electro-assisted tension-compression cyclic loading device for ultra-thin titanium plates provided by an embodiment of the present invention, FIG. 2 is a schematic structural diagram of a packaging structure of an electro-assisted tension-compression cyclic loading device for ultra-thin titanium plates provided by an embodiment of the present invention, and FIG. 3 is a schematic structural diagram of a first orientation of a composite tension-compression specimen provided by an embodiment of the present invention. As shown in FIG. 1, FIG. 2 and FIG. 3, an embodiment of the present invention provides an electro-assisted tension-compression cyclic loading device for ultra-thin titanium plates, including: two outer specimens 1 used in conjunction with the ultra-thin titanium plate specimen 2 and two pairs of electro-assisted fixtures. The two outer specimens 1 are fixed on both sides of the ultra-thin titanium plate specimen 2, and the three form a composite tension-compression specimen. It should be understood that the composite tension-compression specimen should ensure a moderate thickness. If it is too thin, it is still easy to twist during the compression process, and if it is too thick, the specimen is not easy to be clamped. At the same time, the two outer specimens 1 are fixed on both sides of the ultra-thin titanium plate specimen 2 to form a composite tension-compression specimen structure, which can also ensure uniform force transmission. The ends of the ultra-thin titanium plate specimen 2 extend beyond the ends of the outer specimens 1 to ensure that the ultra-thin titanium plate specimen 2 is in contact with the conductive structure 15, ensuring that current accurately enters the ultra-thin titanium plate specimen 2. After the two sides of the composite tension-compression specimen are fixed by the clamping assembly, lateral force is applied to it. The clamping assembly fixes the composite tension-compression specimen to ensure that it does not undergo torsional buckling during the loading process. Mechanical clamping, hydraulic clamping or pneumatic clamping can be used, and the specific choice depends on the test requirements. The two pairs of electro-assisted fixtures are respectively clamped at both ends of the composite tension-compression specimen. Each pair of electro-assisted fixtures includes two oppositely arranged clamping heads 11. The clamping surface of the clamping head 11 has a conductive structure 15. The conductive structure 15 is usually made of a highly conductive material such as copper or silver to ensure efficient current transmission and reduce energy loss. The conductive structure can be designed as multi-point contact or surface contact to optimize current distribution and heating uniformity. The conductive structure 15 is connected to an external power supply. When the composite tension-compression specimen is clamped on the clamping head 11, the conductive structure 15 contacts the composite tension-compression specimen to transfer current to the composite tension-compression specimen through the conductive structure 15 to heat it. The external power supply provides the required current, and the current magnitude is adjustable to adapt to different heating needs. The current magnitude and heating time are adjusted through the control system to ensure that the composite tension-compression specimen is tested at a set temperature. The clamping head 11 is connected to the loading end of the universal testing machine, and tensile and compressive forces are applied through the universal testing machine. The universal testing machine can accurately control the loading speed and number of cycles, and the current magnitude is controlled by an external power supply to meet different test conditions and achieve electro-thermal coupling loading.

The electro-assisted tension-compression cyclic loading device for ultra-thin titanium plates provided by the embodiment of the present invention is used for the compression test of thin plates with a thickness of less than 1 mm. By fixing two outer specimens on both sides of the original ultra-thin titanium plate specimen to form an integral composite tension-compression specimen, the thickness of the specimen is increased, which can avoid instability and buckling during the compression process. At the same time, two pairs of electro-assisted fixtures clamp the composite tension-compression specimen, and the conductive structure on each clamping head of the electro-assisted fixture is directly connected to the composite tension-compression specimen to heat it. By connecting the composite tension-compression specimen with the electro-assisted fixture to form a whole to replace the original ultra-thin titanium plate specimen, it avoids setting a wire interface on the specimen, thereby further avoiding torsional deformation of the specimen, solving the problem of wrinkling of the ultra-thin plate under compressive load, and ensuring the smooth progress of the test. Then, the clamping head is connected to the loading end of the universal testing machine, which can be used to characterize the mechanical behavior of the ultra-thin titanium plate under complex loading paths in the presence of current, and provide theoretical support for the electro-assisted forming process.

Specifically, in the embodiment of the present invention, the resistivity of the outer specimen 1 is 1012 Ω·m-1017 Ω·m. When the resistivity of the outer specimen 1 is 1012 Ω·m-1017 Ω·m, it can be considered insulated, and the current has basically no effect on the outer specimen 1. In this way, when the clamping head 11 clamps the composite tension-compression specimen, it is not necessary to repeatedly adjust the position of the composite tension-compression specimen, as long as it is ensured that the ultra-thin titanium plate specimen 2 contacts the conductive structure 15. And the outer specimen 1 can contact or not contact the conductive structure 15. In this way, it is not necessary to separately measure the mechanical properties of the outer specimen 1 and the stress conditions during the tension-compression process in the presence of current.

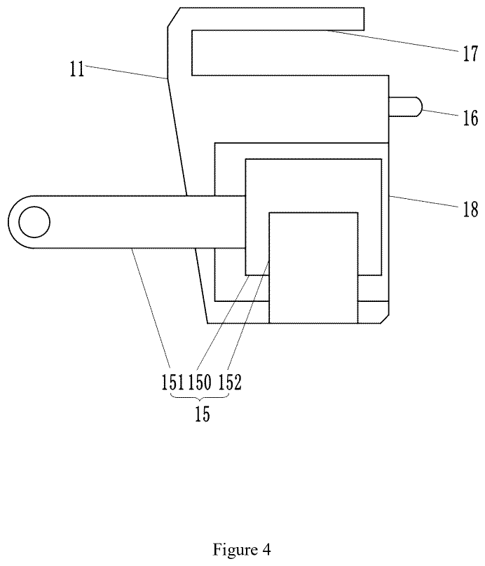

Referring to FIG. 4, FIG. 4 is a schematic structural diagram of the clamping head provided by an embodiment of the present invention. As shown in FIG. 4, the conductive structure 15 includes a conductive sheet 150 and a connecting sheet 151 that are integrally connected. Both the conductive sheet 150 and the connecting sheet 151 are made of conductive materials, such as copper. The conductive sheet 150 is located on the clamping surface of the clamping head 11, and the side in contact with the composite tension-compression specimen has serrations. The conductive sheet 150 is also provided with a through groove 152. The end of the outer specimen 1 is placed in the through groove 152, and the ultra-thin titanium plate specimen 2 contacts the conductive sheet 150. The conductive sheet 150 is responsible for transmitting current and heating the ultra-thin titanium plate specimen 2. The connecting sheet 151 is connected to an external power supply and is responsible for transmitting the current from the external power supply to the conductive sheet 150.

The conductive sheet 150 is also provided with a through groove 152, and the end of the outer specimen 1 is placed in the through groove 152, thereby increasing the thickness clamped by the clamping head 11, increasing the clamping force of the clamping head 11 on the composite tension-compression specimen, preventing the composite tension-compression specimen from sliding, and also ensuring that the current is directly transmitted to the ultra-thin titanium plate specimen 2. The conductive sheet 150 is located on the clamping surface of the clamping head 11, and the side in contact with the composite tension-compression specimen has serrations, which can increase the contact area and friction force, prevent the composite tension-compression specimen from sliding, and optimize the current distribution. When the clamping head 11 clamps the composite tension-compression specimen, the serrated structure of the conductive sheet 150 is in close contact with the composite tension-compression specimen, ensuring uniform current transmission and heating of the ultra-thin titanium plate specimen 2.

Referring again to FIG. 4, the upper and lower two fixtures of the universal testing machine correspondingly clamp two pairs of electro-assisted fixtures. The clamping head 11 also has a positioning post 16 and a fixing groove 17. The positioning post 16 cooperates with the positioning groove of the universal testing machine, thereby achieving the purpose of quickly completing the connection and alignment with the universal testing machine, accurately positioning the relative positions of the electro-assisted fixture and the universal testing machine fixture, and ensuring centering and stability during the loading process. The loading head of the universal testing machine is snapped into the fixing groove 17, and the force can be accurately transmitted to the composite tension-compression specimen through the loading head. It should be noted that the clamping head 11 also has an insulating layer 18. The insulating layer 18 is located under the conductive sheet 150 and is made of PEEK polyetheretherketone insulating material. The main body of the clamping head 11 is made of iron, which has high strength and ensures that the electro-assisted fixture will not be damaged under repeated use.

In this embodiment, the thickness of the outer specimen 1 is 0.5 mm-0.7 mm, and the material is one of glass fiber composite material or polyetheretherketone or carbon fiber-glass fiber composite material or other composite materials with good insulation, high temperature resistance and elongation. After the ultra-thin titanium plate specimen 2 is clamped by the outer specimen 1 on both sides, the thickness should be moderate. If the specimen is too thin, it is easy to twist during the compression process, and if the specimen is too thick, it is not easy to be clamped. When glass fiber is selected, it is because its resistivity is large and its elastic limit is also large. It is generally elastic deformation in the tension-compression test, which is convenient for calculating the stress conditions during the tension-compression process, but the elongation at break is small, and it can be used for tension-compression cyclic loading tests with small strain. Polyetheretherketone has good elongation and can be used for tension-compression cyclic loading under high strain, and has good strength and hardness to ensure the smooth progress of the test.

In this embodiment, the outer specimen 1 and the ultra-thin titanium plate specimen 2 are bonded and fixed by epoxy resin, and the layer thickness of the epoxy resin is 0.02 mm-0.05 mm. If the layer thickness of the epoxy resin is too thick, it will affect the stress calculation of the ultra-thin titanium plate specimen 2 during the tensile and compression process. Selecting a layer thickness of 0.02 mm-0.05 mm in this range can ignore the tensile and compressive forces received by the resin layer, which is convenient for subsequent calculations.

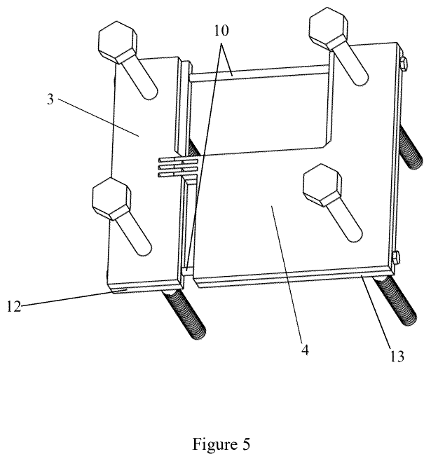

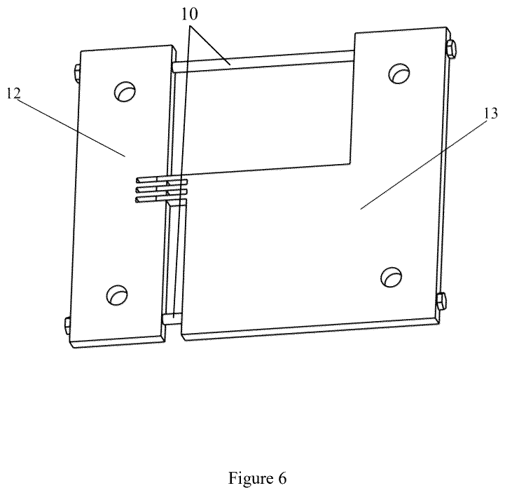

Referring to FIG. 5 and FIG. 6, FIG. 5 is a schematic structural diagram of the first insulating sheet and the second insulating sheet provided by an embodiment of the present invention, and FIG. 6 is a schematic structural diagram of the first clamping plate and the second clamping plate provided by an embodiment of the present invention. As shown in FIG. 5 and FIG. 6, in the embodiment of the present invention, the clamping assembly includes: two insulating gaskets arranged on both sides of the composite tension-compression specimen in a center-symmetrical manner, each insulating gasket including a first insulating sheet 3 and a second insulating sheet 4 stacked along the extending direction of the ultra-thin titanium plate specimen 2, and two clamping plates arranged on the outer sides of the two insulating gaskets in a center-symmetrical manner. The outer side of the clamping plate is connected with a lateral force adjusting assembly to adjust the clamping force of the clamping plate and the insulating gasket on the composite tension-compression specimen. Each clamping plate includes a stacked first clamping plate 12 and a second clamping plate 13. The first clamping plate 12 is fixedly connected with the corresponding first insulating sheet 3, and the second clamping plate 13 is fixedly connected with the corresponding second insulating sheet 4. The first insulating sheet 3 and the second insulating sheet 4, and the first clamping plate 12 and the second clamping plate 13 are each slidably connected through a plurality of straight rods 10, so that the first insulating sheet 3 and the second insulating sheet 4, and the first clamping plate 12 and the second clamping plate 13 move synchronously along the extending direction of the ultra-thin titanium plate specimen 2. In this embodiment, the insulating gasket is used to isolate current. Since the melting point of the insulating material is generally low, between 200° C.-300° C., the increase in specimen temperature during the electro-assisted process will cause the insulating gasket to soften and cannot well transmit the lateral force. Therefore, a clamping plate is further arranged on the outer layer of the insulating gasket. The clamping plate is used to transmit the lateral force, and the through grooves opened at the same position of the insulating gasket and the clamping plate can facilitate DIC measurement of strain.

The first insulating sheet 3 and the second insulating sheet 4 are connected to the first clamping plate 12 and the second clamping plate 13 through bolts and realize free movement perpendicular to the direction of the clamping plate through the first clamping plate 12 and the second clamping plate 13 to realize the tensile and compression cyclic loading process. In order to prevent the clamping plate and the insulating gasket from being misaligned up and down, there are straight rods 10 between the first insulating sheet 3 and the second insulating sheet 4, and between the first clamping plate 12 and the second clamping plate 13, which play a role of centering and guiding. And the clamping plates and insulating gaskets on the left and right sides of the specimen are distributed in a center-symmetrical manner to prevent the specimen from twisting in the comb-shaped area of the insulating gasket and the clamping plate.

Specifically, the first insulating sheet 3 and the second insulating sheet 4, and the first clamping plate 12 and the second clamping plate 13 are each connected through a comb-shaped structure. The comb-shaped structure ensures that all sections can be constrained by lateral force when the composite tension-compression specimen is compressed after being stretched. The movement is realized through the comb-shaped structure in the non-gauge section without reducing the buckling resistance of the device, further avoiding its buckling deformation, and can realize the tension-compression cyclic loading of the ultra-thin titanium plate specimen 2.

Referring again to FIG. 2, in this embodiment, the lateral force adjusting assembly includes: two inner plates 9, two outer plates 8 and a spring 5. The two inner plates 9 are respectively placed on the outer sides of the corresponding clamping plates, and the two outer plates 8 are respectively placed on the outer sides of the corresponding inner plates 9. Both the inner plate 9 and the outer plate 8 are provided with sliding holes extending along the extending direction of the ultra-thin titanium plate specimen 2. The screw rods sequentially pass through the sliding holes and are fixed to the clamping plate and the insulating gasket. A spring adjusting block 6 is rotatably connected to one of the outer plates 8. One end of the spring 5 is fixedly connected to the spring adjusting block 6, and the other end is fixedly connected to the corresponding inner plate 9. The compression amount of the spring 5 is adjusted by rotating the spring adjusting block 6, thereby adjusting the lateral force applied to the inner plate 9 on one side.

The spring adjusting block 6 can freely rotate the spring 5 at the outer plate 8. The spring 5 is compressed when the spring adjusting block 6 is rotated downward, and the bolts at the outer plate 8 are adjusted at the same time to make the outer plate 8 closely adhere to the spring adjusting block 6, so that the lateral force is transmitted from the inner plate 9 to both sides of the composite tension-compression specimen through the spring 5. By this way, it is convenient to adjust by only setting the spring adjusting block 6 and the spring 5 on one side, and the lateral force can be collected by the force sensor 7 on the other side.

In a second aspect, the present invention provides a test method based on the above-described electric-assisted tension-compression cyclic loading device for ultra-thin titanium plates, comprising the following steps:
Step 1: Prepare a composite tension-compression specimen by fixing outer specimens 1 on both sides of the ultra-thin titanium plate specimen 2 to form the composite tension-compression specimen;
Step 2: Clamp the prepared composite tension-compression specimen onto a universal testing machine using an electric-assisted fixture, and apply lateral force to the composite tension-compression specimen through clamping components on both sides for fixation;
Step 3: Set the parameters required for the tension-compression test and perform the tension-compression test;
Step 4: Observe whether buckling occurs in the ultra-thin titanium plate specimen 2. If buckling occurs, adjust the lateral force, and then repeat steps 1-4 until buckling does not occur in the ultra-thin titanium plate specimen 2, and obtain the corresponding lateral force when buckling does not occur;
Step 5: Use the lateral force corresponding to the non-buckling state to fix the remaining composite tension-compression specimens, and perform a tension-compression test to obtain experimental data, and use the experimental data to obtain a stress-strain curve.

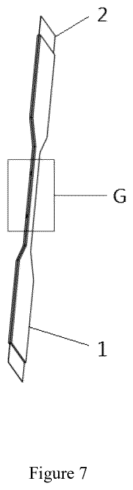

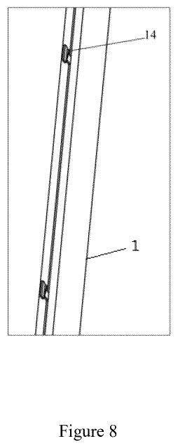

The specific implementation is as follows:
1) Prepare a composite tension-compression specimen by bonding outer specimens 1 with a thickness of 0.5 mm to 0.7 mm to both sides of the ultra-thin titanium plate specimen 2 using epoxy resin, the thickness of the epoxy resin layer is about 0.05 mm, and the specimen is cured after bonding to ensure that the outer specimen 1 and the ultra-thin titanium specimen 2 are tightly attached to form a composite tension-compression specimen;
2) Spray speckles on the thickness direction of the prepared composite tension-compression specimen for DIC strain measurement;
3) Clamp the prepared composite tension-compression specimen onto a universal testing machine using an electric-assisted fixture, apply a lubricant with a thickness of about 0.1 mm to the gauge section and surrounding area on both sides of the composite tension-compression specimen to ensure sufficient lubrication, so as to reduce the friction between the composite tension-compression specimen and the insulating pad, and then install the first clamping plate 12, the second clamping plate 13, the straight rod 10, the spring 5, the spring adjusting block 6, the outer plate 8, the inner plate 9, and the force sensor 7 in sequence, and separate the first clamping plate 12 and the second clamping plate 13 by a distance for compression. After the installation is completed, connect the force sensor 7 in the device to a computer to obtain the lateral force Fc applied to the composite tension-compression specimen;
4) Adjust the spring adjusting block 6 to clamp the composite tension-compression specimen, and record the screwing-in amount x;
5) Set the parameters required for the tension-compression test and perform the tension-compression test;
6) Observe whether buckling occurs in the ultra-thin titanium plate specimen 2. If buckling occurs, remove the buckled composite tension-compression specimen, adjust the screwing-in amount x in step 4 to 1.5 times the previous value, and repeat steps 1-6 until buckling does not occur in the ultra-thin titanium plate specimen 2, and then continue with the following steps;
7) If buckling does not occur, record the current screwing-in amount x, take a new composite tension-compression specimen, re-clamp it, and adjust the screwing-in amount to x, and start the following steps;
8) Set the current parameters and test conditions, start the power supply, the current is transmitted to the composite tension-compression specimen through the electric-assisted fixture, heat the ultra-thin titanium plate specimen 2 to a predetermined temperature, and monitor the temperature through the thermocouple 14, referring to FIG. 7 and FIG. 8;
9) Start the universal testing machine to perform the tension-compression cyclic loading test;
10) After the test is completed, adjust the spring adjusting block 6 to loosen the clamping plate, and remove the composite tension-compression specimen;
11) Calculate the force FTi=FA−Ff−Fgf on the ultra-thin titanium plate specimen 2 during the tension-compression process through the data measured by the universal testing machine and the force sensor 7, where FA is the force on the composite tension-compression specimen, Ff is the friction force, and Fgf is the force on the outer specimen 1 during the tension-compression process;
12) The friction force is equal to the lateral force multiplied by the friction coefficient, that is, Ff=2Fc*μ, where μ can be measured by an electric-assisted friction coefficient test;
13) If the outer specimen 1 is always in an elastic state during the deformation process, Fgf can be calculated by the elastic modulus Egf and the strain. If the outer specimen 1 enters the plastic stage during the deformation process, since the outer specimen 1 is not affected by the current during the insulation electric-assisted process, its force situation Fgf during the tension-compression process can be obtained through a thin plate tension-compression test;
14) Obtain the force magnitude of each part of the specimen during the tension-compression process, and then the force magnitude FTi on the ultra-thin titanium plate specimen 2 during the tension-compression process can be calculated by the formula FTi=FA−Ff−Fgf;
15) The stress-strain curve during the electric-assisted ultra-thin titanium plate tension-compression cyclic loading process can be calculated from the FTi value and the strain measured by DIC.

The above are only a few specific embodiments of the present invention. However, the embodiments of the present invention are not limited thereto, and any changes that those skilled in the art can think of should fall within the protection scope of the present invention.

1. A thin titanium plate electro-assisted tension-compression cyclic loading device, comprising:
two outer specimens (1) used in conjunction with a thin titanium plate specimen (2), wherein the two outer specimens (1) are fixed on two sides of the thin titanium plate specimen (2), wherein the three specimens form a composite tension-compression specimen, wherein ends of said thin titanium plate specimen (2) extend beyond ends of the outer specimens (1), and a lateral force can be applied to both sides of said composite tension-compression specimen after being fixed by a clamping assembly;
two pairs of electro-assisted clamps, clamping two ends of said composite tension-compression specimen, wherein each pair of said electro-assisted clamps comprises two clamping heads (11) arranged oppositely, wherein said clamping heads (11) have a conductive structure (15) on their clamping surfaces, wherein said conductive structure (15) is connected to an external power supply, and wherein, when said composite tension-compression specimen is clamped on said clamping head (11), said conductive structure (15) contacts the composite tension-compression specimen to transfer current to the composite tension-compression specimen through said conductive structure (15) to heat it, and further wherein said clamping head (11) is connected to a loading end of a universal testing machine;
wherein said clamping assembly comprises:
two insulating shims arranged on both sides of the composite tension-compression specimen in a center-symmetrical manner, wherein each insulating shim comprises a first insulating sheet (3) and a second insulating sheet (4) stacked in the extending direction of the thin titanium plate specimen (2);
wherein two clamping plates are arranged on the outside of the two insulating shims in a center-symmetrical manner, and the outside of said clamping plate is connected with a lateral force adjusting assembly, and each said clamping plate comprises a stacked first clamping plate (12) and a second clamping plate (13), wherein said first clamping plate (12) is fixedly connected with the corresponding first insulating sheet (3), and said second clamping plate (13) is fixedly connected with the corresponding second insulating sheet (4), wherein said first insulating sheet (3), said second insulating sheet (4), said first clamping plate (12) and said second clamping plate (13) are slidably connected by a plurality of straight rods (10), so that said first insulating sheet (3), said second insulating sheet (4), said first clamping plate (12) and said second clamping plate (13) move synchronously along the extending direction of the thin titanium plate specimen (2).

2. The thin titanium plate electro-assisted tension-compression cyclic loading device according to claim 1, wherein said conductive structure (15) comprises an integrated conductive sheet (150) and a connecting sheet (151), wherein said conductive sheet (150) and connecting sheet (151) are both made of conductive material, wherein said conductive sheet (150) is located on the clamping surface of the clamping head (11), and has serrations on the side contacting the composite tension-compression specimen, and wherein said conductive sheet (150) is also provided with a through slot (152), wherein the end of said outer specimen (1) is placed in said through slot (152), said thin titanium plate specimen (2) contacts the conductive sheet (150), and said connecting sheet (151) is connected to an external power supply.

3. The thin titanium plate electro-assisted tension-compression cyclic loading device according to claim 2, wherein resistivity of said outer specimen (1) is 1012 Ω·m-1017 Ω·m.

4. The thin titanium plate electro-assisted tension-compression cyclic loading device according to claim 1, wherein the upper and lower two clamps of said universal testing machine correspondingly clamp two pairs of electro-assisted clamps, and said clamping head (11) also has a positioning post (16) and a fixing groove (17), wherein said positioning post (16) cooperates with the positioning groove of the universal testing machine, and the loading head of the universal testing machine is snapped into said fixing groove (17).

5. The thin titanium plate electro-assisted tension-compression cyclic loading device according to claim 1, wherein the thickness of said outer specimen (1) is 0.5 mm-0.7 mm, and the material is one of glass fiber composite material or polyetheretherketone or carbon fiber-glass fiber composite material.

6. The thin titanium plate electro-assisted tension-compression cyclic loading device according to claim 5, wherein said outer specimen (1) and the thin titanium plate specimen (2) are adhesively fixed by epoxy resin, and the layer thickness of said epoxy resin is 0.02 mm-0.05 mm.

7. The thin titanium plate electro-assisted tension-compression cyclic loading device according to claim 1, wherein said first insulating sheet (3), said second insulating sheet (4), said first clamping plate (12) and said second clamping plate (13) are each also connected by a comb-like structure.

8. The thin titanium plate electro-assisted tension-compression cyclic loading device according to claim 1, wherein said lateral force adjusting assembly comprises:
two inner plates (9), respectively placed on the outside of the corresponding clamping plates;
two outer plates (8), respectively placed on the outside of the corresponding inner plates (9), wherein said inner plate (9) and outer plate (8) are each provided with a sliding hole in the extending direction of the thin titanium plate specimen (2), and a screw passes through the sliding hole in sequence and is fixed with the clamping plate and the insulating shim, wherein one of said outer plates (8) is rotatably connected with a spring adjusting block (6);
a spring (5), wherein one end of the spring is fixedly connected with said spring adjusting block (6), and the other end is fixedly connected with the corresponding inner plate (9).

9. A testing method based on the thin titanium plate electro-assisted tension-compression cyclic loading device according to claim 1, comprising the following steps:
Step 1: preparing a composite tension-compression specimen by fixing outer specimens (1) on both sides of the thin titanium plate specimen (2) to form a composite tension-compression specimen;
Step 2: clamping the prepared composite tension-compression specimen to a universal testing machine through electro-assisted clamps, and applying lateral force to the composite tension-compression specimen through a clamping assembly on both sides for fixation;
Step 3: setting parameters required for the tension-compression test, and performing the tension-compression test;
Step 4: observing whether the thin titanium plate specimen (2) buckles, and if buckling occurs, adjusting the lateral force, and then repeating steps 1-step 4 until the thin titanium plate specimen (2) does not buckle, and obtaining the corresponding lateral force when buckling does not occur;
Step 5: using the corresponding lateral force when buckling does not occur to fix the remaining composite tension-compression specimens, and performing a tension-compression test to obtain experimental data, and using the experimental data to obtain a stress-strain curve.
